(19) United States
(12) Patent Application Publication
(10) Pub. No.: US 2015/0205526 A1
(43) Pub. Date: Jul. 23, 2015

(54) QUEUING LATENCY FEEDBACK MECHANISM TO IMPROVE I/O PERFORMANCE

(71) Applicant: International Business Machines Corporation, Armonk, NY (US)

(72) Inventors: David D. Chambliss, Morgan Hill, CA (US); Bruce McNutt, Gilroy, CA (US); William G. Sherman, Tucson, AZ (US); Yan Xu, Tucson, AZ (US)

(73) Assignee: International Business Machines Corporation, Armonk, NY (US)

(21) Appl. No.: 14/158,807

(22) Filed: Jan. 18, 2014

(51) Int. Cl. G06F 3/06

(52) U.S. Cl. CPC G06F 3/061; G06F 3/067; G06F 3/0659

(57) ABSTRACT

A method for improving I/O performance using queuing latency feedback initially generates, at a host system, I/O for processing on a storage system. The I/O is received at the storage system and queuing latency experienced by the I/O is measured as the I/O is processed by the storage system. The queuing latency is returned to the host system. The host system may use the queuing latency to understand delays and resource contention within the storage system and enable the host system to more effectively take actions that improve I/O performance and compliance with SLAs. A corresponding system and computer program product are also disclosed.

### BACKGROUND

1. Field of the Invention

This invention relates to apparatus and methods for using queuing latency feedback to improve I/O performance.

2. Background of the Invention

In storage networks such as storage area networks (SANs), one or more servers (referred to herein as “hosts” or “host systems”) may access data in one or more storage systems. Each host system may manage one or more applications, each of which may manage one or more I/O workstreams to a storage system. Managing these I/O workstreams is often critical to complying with service level agreements (SLAs). To comply with an SLA, the host system may send priority hints to the storage system on an I/O by I/O basis. The storage system may use these priority hints to prioritize and de-prioritize I/O requests within the storage system. The host system can measure compliance with an SLA and adjust the priority hints accordingly.

Problems may occur when host systems make decisions without understanding latencies within a storage system. For example, a storage system may service I/O requests on storage devices with different latency characteristics, such as lower performance disk drives with higher latency, higher performance disk drives with lower latency, and solid state drives with even lower latency.

Consider a high priority host application that is not complying with an SLA. In an attempt to comply with the SLA, the host application may raise the priority of the I/O workstream. In cases where the I/O is on lower performance disk drives and the I/O is performing at near optimal levels on the lower performance disk drives, raising the priority of an I/O workstream (which may slow down or place back pressure on other I/O workstreams) may not improve the performance of the I/O workstream, while negatively impacting the performance of other I/O workstreams. In some cases, a host volume may be spread across different types of storage media, each having different performance and latency characteristics. Because a host application may be unaware of underlying storage system latencies, which may have significant effects on I/O performance, the host application may raise and lower I/O priorities in ways that are ineffective and possibly counterproductive.

In view of the foregoing, what are needed are mechanisms to provide host systems more useful information about latencies within a storage system. Ideally such mechanisms will enable host systems (and system administrators) to make more intelligent decisions with regard to complying with SLAs.

### SUMMARY

The invention has been developed in response to the present state of the art and, in particular, in response to the problems and needs in the art that have not yet been fully solved by currently available apparatus and methods. Accordingly, the invention has been developed to improve I/O performance using queuing latency feedback. The features and advantages of the invention will become more fully apparent from the following description and appended claims, or may be learned by practice of the invention as set forth hereinafter.

Consistent with the foregoing, a method for improving I/O performance using queuing latency feedback is disclosed. The method initially generates, at a host system, I/O for processing on a storage system. The I/O is received at the storage system and queuing latency experienced by the I/O is measured as the I/O is processed by the storage system. The queuing latency is returned to the host system. The host system may use the queuing latency to understand delays and resource contention within the storage system and enable the host system to more effectively take actions that improve I/O performance and compliance with SLAs.

A corresponding system and computer program product are also disclosed and claimed herein.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 is a high-level block diagram showing one example of a storage network in which a queuing latency feedback mechanism in accordance with the invention may be implemented;

FIG. 2 is a high-level block diagram showing one example of a storage system in which a queuing latency feedback mechanism in accordance with the invention may be implemented;

FIG. 3 is a high-level block diagram showing various modules that may be used to implement a queuing latency feedback mechanism in accordance with the invention;

FIG. 4 is a high-level block diagram showing one technique for aggregating queuing latencies within a storage system;

FIG. 5 is a high-level block diagram showing another technique for aggregating queuing latencies within a storage system; and

FIG. 6 is a flow diagram showing one embodiment of a method for generating queuing latency feedback and using the queuing latency feedback to make more intelligent decisions with regard to complying with SLAs.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

As will be appreciated by one skilled in the art, the present invention may be embodied as an apparatus, system, method, or computer program product. Furthermore, the present invention may take the form of a hardware embodiment, a software embodiment (including firmware, resident software, micro-code, etc.) configured to operate hardware, or an embodiment combining software and hardware aspects that may all generally be referred to herein as a “module” or “system.” Furthermore, the present invention may take the form of a computer-usable storage medium embodied in any tangible medium of expression having computer-usable program code stored therein.

Any combination of one or more computer-usable or computer-readable storage medium(s) may be utilized to store the computer program product. The computer-usable or computer-readable storage medium may be, for example but not limited to, an electronic, magnetic, optical, electromagnetic, infrared, or semiconductor system, apparatus, or device. More specific examples (a non-exhaustive list) of the computer-readable storage medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, or a magnetic storage device. In the context of this document, a computer-usable or computer-readable storage medium may be any medium that can contain, store, or transport the program for use by or in connection with the instruction execution system, apparatus, or device.

Computer program code for carrying out operations of the present invention may be written in any combination of one or more programming languages, including an object-oriented programming language such as Java, Smalltalk, C++, or the like, and conventional procedural programming languages, such as the “C” programming language or similar programming languages. Computer program code for implementing the invention may also be written in a low-level programming language such as assembly language.

The present invention may be described below with reference to flowchart illustrations and/or block diagrams of methods, apparatus, systems, and computer program products according to embodiments of the invention. It will be understood that each block of the flowchart illustrations and/or block diagrams, and combinations of blocks in the flowchart illustrations and/or block diagrams, may be implemented by computer program instructions or code. These computer program instructions may be provided to a processor of a general-purpose computer, special-purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The computer program instructions may also be stored in a computer-readable storage medium that can direct a computer or other programmable data processing apparatus to function in a particular manner, such that the instructions stored in the computer-readable storage medium produce an article of manufacture including instruction means which implement the function/act specified in the flowchart and/or block diagram block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

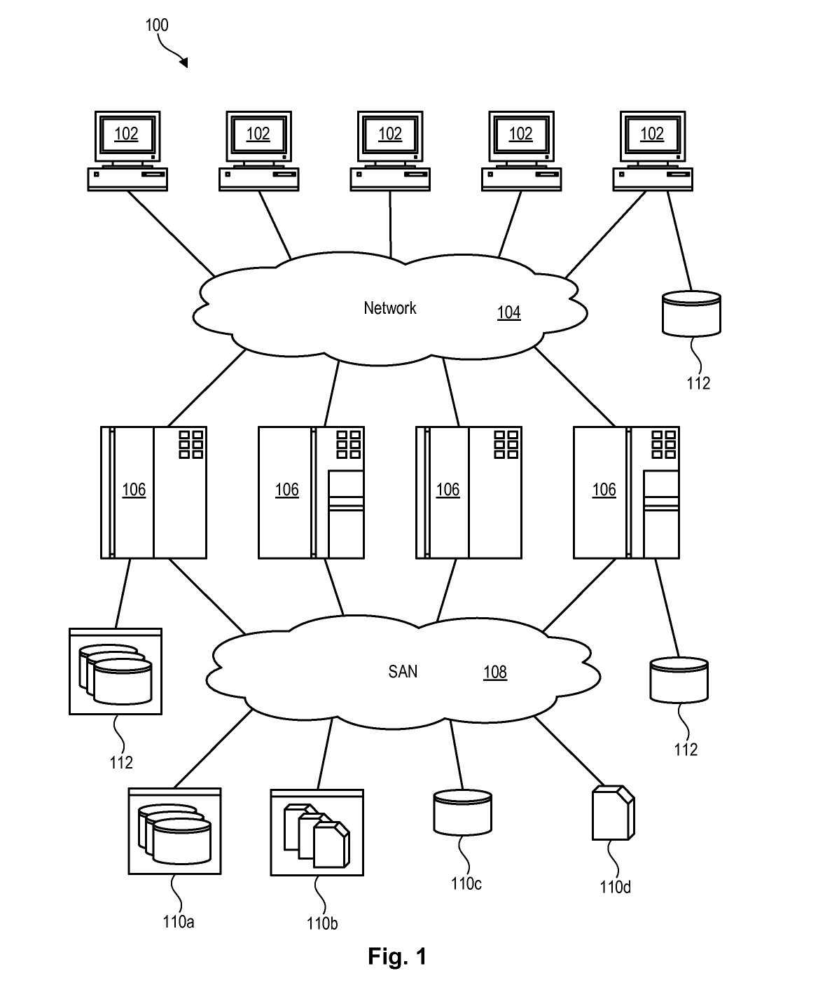

Referring to FIG. 1, one example of a network architecture 100 is illustrated. The network architecture 100 is presented to show one example of an environment where an apparatus and method in accordance with the invention may be implemented. The network architecture 100 is presented only by way of example and not limitation. Indeed, the apparatus and methods disclosed herein may be applicable to a wide variety of network architectures, in addition to the network architecture 100 shown.

As shown, the network architecture 100 includes one or more computers 102, 106 interconnected by a network 104. The network 104 may include, for example, a local-area-network (LAN) 104, a wide-area-network (WAN) 104, the Internet 104, an intranet 104, or the like. In certain embodiments, the computers 102, 106 may include both client computers 102 and server computers 106 (also referred to herein as “host systems” 106). In general, the client computers 102 initiate communication sessions, whereas the server computers 106 wait for requests from the client computers 102. In certain embodiments, the computers 102 and/or servers 106 may connect to one or more internal or external direct-attached storage systems 112 (e.g., arrays of hard-disk drives, solid-state drives, tape drives, etc.). These computers 102, 106 and direct-attached storage systems 112 may communicate using protocols such as ATA, SATA, SCSI, SAS, Fibre Channel, or the like.

The network architecture 100 may, in certain embodiments, include a storage network 108 behind the servers 106, such as a storage-area-network (SAN) 108 or a LAN 108 (e.g., when using network-attached storage). This network 108 may connect the servers 106 to one or more storage systems 110, such as arrays 110a of hard-disk drives or solid-state drives, tape libraries 110b, individual hard-disk drives 110c or solid-state drives 110c, tape drives 110d, CD-ROM libraries, or the like. To access a storage system 110, a host system 106 may communicate over physical connections from one or more ports on the host 106 to one or more ports on the storage system 110. A connection may be through a switch, fabric, direct connection, or the like. In certain embodiments, the servers 106 and storage systems 110 may communicate using a networking standard such as Fibre Channel (FC). One or more of the storage systems 110 may utilize the apparatus and methods disclosed herein.

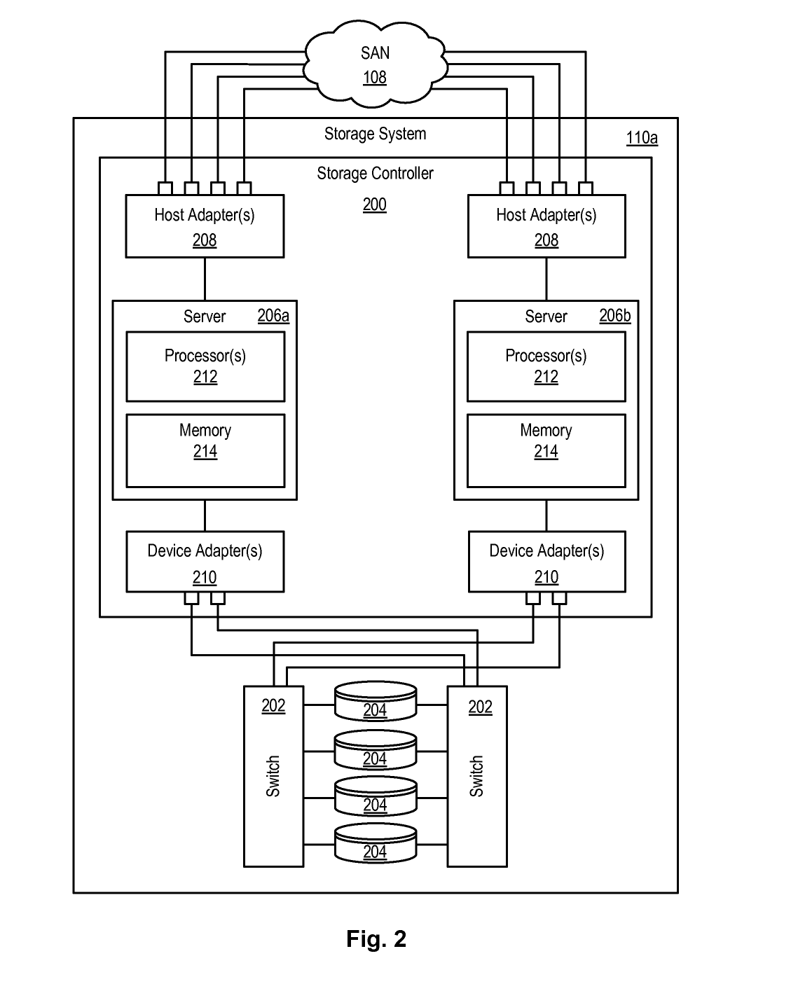

Referring to FIG. 2, one embodiment of a storage system 110a containing an array of hard-disk drives 204 and/or solid-state drives 204 is illustrated. The internal components of the storage system 110a are shown since, in certain embodiments, a queuing latency feedback mechanism in accordance with the invention may be implemented within such a storage system 110a, although the queuing latency feedback mechanism may also be implemented in other types of storage systems 110. As shown, the storage system 110a includes a storage controller 200, one or more switches 202, and one or more storage devices 204, such as hard disk drives 204 or solid-state drives 204 (such as flash-memory-based drives 204). The storage controller 200 may enable one or more hosts 106 (e.g., open system and/or mainframe servers 106) to access data in the one or more storage devices 204.

In selected embodiments, the storage controller 200 includes one or more servers 206. The storage controller 200 may also include host adapters 208 and device adapters 210 to connect the storage controller 200 to host devices 106 and storage devices 204, respectively. Multiple servers 206a, 206b may provide redundancy to ensure that data is always available to connected hosts 106. Thus, when one server 206a fails, the other server 206b may pick up the I/O load of the failed server 206a to ensure that I/O is able to continue between the hosts 106 and the storage devices 204. This process may be referred to as a “failover.”

One example of a storage system 110a having an architecture similar to that illustrated in FIG. 2 is the IBM DS8000™ enterprise storage system. The DS8000™ is a high-performance, high-capacity storage controller providing disk storage that is designed to support continuous operations. Nevertheless, the apparatus and methods disclosed herein are not limited to the IBM DS8000™ enterprise storage system 110a, but may be implemented in any comparable or analogous storage system 110, regardless of the manufacturer, product name, or components or component names associated with the system 110. Furthermore, any storage system that could benefit from one or more embodiments of the invention is deemed to fall within the scope of the invention. Thus, the IBM DS8000™ is presented only by way of example and is not intended to be limiting.

In selected embodiments, each server 206 may include one or more processors 212 and memory 214. The memory 214 may include volatile memory (e.g., RAM) as well as non-volatile memory (e.g., ROM, EPROM, EEPROM, hard disks, flash memory, etc.). The volatile and non-volatile memory may, in certain embodiments, store software modules that run on the processor(s) 212 and are used to access data in the storage devices 204. The servers 206 may host at least one instance of these software modules. These software modules may manage all read and write requests to logical volumes in the storage devices 204.

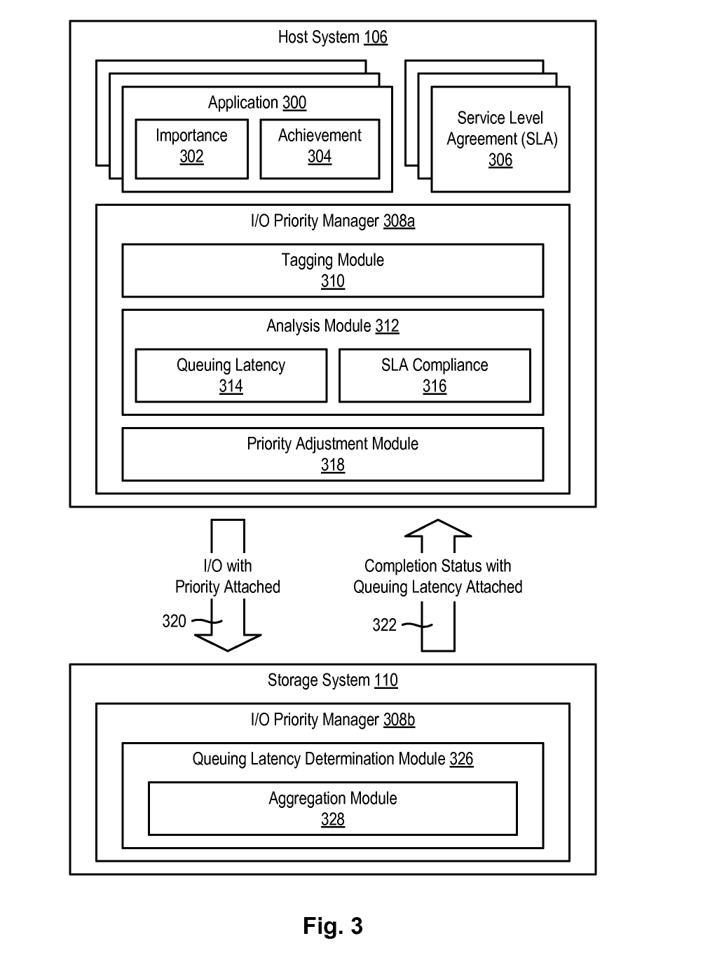

Referring to FIG. 3, a high-level block diagram showing various modules that may be used to implement a queuing latency feedback mechanism in accordance with the invention is illustrated. As shown, a host system 106 and storage system 110 may include one or more modules providing various features and functions. These modules may be implemented in hardware, software or firmware executable on hardware, or a combination thereof. The modules are presented only by way of example and are not intended to be limiting. Indeed, alternative embodiments may include additional or fewer modules than those illustrated, or the modules may be organized differently. Furthermore, in some embodiments, the functionality of some modules may be broken into multiple modules or, conversely, the functionality of several modules may be combined into a single or fewer modules.

As shown, a host system 106 may include one or more applications 300, each of which may manage one or more I/O workstreams to a storage system 110. Managing these I/O workstreams may be needed to comply with various service level agreements (SLAs) 306. To comply with an SLA 306, the host system 106 may send priority hints to the storage system 110 on an I/O by I/O basis. The storage system 110 may use these priority hints to prioritize and de-prioritize I/O requests within the storage system 110. A host system 106 may measure compliance with an SLA 306 and adjust priority hints accordingly.

In certain embodiments, the priority hints may include different types of information. For example, a priority hint may indicate an importance 302 of an application 300, as well as achievement 304 of the application 300. The importance 302 may be set by an administrator and remain constant (unless changed by the administrator), while the achievement 304 may vary in accordance with an application's compliance with an SLA 306. The achievement 304 may be dynamically raised when the application 300 is complying with an SLA 306 and dynamically lowered when the application 300 is not complying with the SLA 306. By examining the achievement 304 attached to an I/O, a storage system 110 may adjust resource allocation within the storage system 110 to help the I/O workstream comply with an SLA 306. As compliance with an SLA 306 changes, the host system 106 may dynamically adjust the priority hints of the I/O workstream accordingly.

In certain embodiments, an I/O priority manager 308 implemented within one or more of the host system 106 and the storage system 110 may manage the priority hints discussed above and adjust resource allocation inside the storage system 110 accordingly. The I/O priority manager 308 may also provide a queuing latency feedback mechanism to provide the host system 106 with more useful information about latencies within the storage system 110. Ideally, the queuing latency feedback mechanism will enable a host system 106 (and possibly a system administrator) to make more intelligent decisions with regard to how to comply with SLAs 306.

As shown in FIG. 3, in certain embodiments, the I/O priority manager 308 may be distributed across the host system 106 and the storage system 110. That is, some functionality of the I/O priority manager 308 may be implemented in the host system 106, while other functionality of the I/O priority manager 308 may be implemented in the storage system 110. Working together, the two components 308a, 308b may provide the queuing latency feedback mechanism discussed above. It should be noted that although certain functionality is shown in the host system 106 while other functionality in shown in the storage system 110, the locations of the functionality is provided simply by way of example and not limitation. Thus, certain functionality shown in the host system 106 may be provided in the storage system 110 and vice versa.

As shown in FIG. 3, in certain embodiments, the I/O priority manager component 308a within the host system 106 includes one or more of a tagging module 310, analysis module 312, and priority adjustment module 318. Similarly, the I/O priority manager component 308b within the storage system 110 includes one or more of a queuing latency determination module 326 and aggregation module 328. The modules are provided by way of example to explain different functionality of the I/O priority manager 308 and are not intended to be limiting.

When the host system 106 generates an I/O request 320 for transmission to the storage system 110, the tagging module 310 may be configured to tag the I/O 320 with a priority so that the storage system 110 can prioritize or de-prioritize the I/O request within the storage system 110. In certain embodiments, this may include tagging the I/O with the importance 302 and/or achievement 304 previously discussed. In general, the priority indicates how the storage system 110 should handle a I/O request relative to other I/O requests in the event of resource contention in the storage system 110.

Upon receiving an I/O request from the host system 106, a queuing latency determination module 326 in the storage system 110 may measure queuing latency associated with the I/O request as the I/O request is processed by the storage system 110. In general, the queuing latency may reflect the delay an I/O request experiences in the storage system 110 as a result of queuing delays or other resource contention in the storage system 110. The queuing latency may be technology and resource dependent, meaning that the queuing latency for a first device (e.g., a lower performance storage drive) may differ from the queuing latency for a second device (e.g., a higher performance storage drive) under the same real-world conditions.

In certain embodiments, measuring the queuing latency may include measuring the queuing latency with respect to an optimal latency of a resource (e.g., storage device 204, device adapter 210, etc.) in the storage system 110. For example, using simple round numbers for illustration, if a storage device 204 can process an I/O request in two microseconds under optimal conditions (where no queuing latency exists), but the storage device requires five microseconds to process the I/O request under real-world conditions, the queuing latency for the I/O request with respect to the storage device 204 would be three microseconds. Similarly, if a device adapter 210 can process an I/O request in one microsecond under optimal conditions (no queuing latency) but requires three microseconds to process the I/O request under real-world conditions, the queuing latency for the I/O request with respect to the device adapter 210 would be two microseconds. This represents one technique for measuring queuing latency and is not intended to be limiting. Other algorithms or techniques (such as techniques using Little's Law) may also be used to measure queuing latency.

In certain embodiments, an aggregation module 328 may aggregate the queuing latencies of devices (e.g., storage devices 204, device adapters 210, host adapters 208, cache or other memory 214, processors 212 etc.) that are used to process an I/O to provide an overall queuing latency. In certain embodiments, the aggregation module 328 only aggregates the queuing latencies of devices that the I/O priority manager 308 manages. For example, the I/O priority manager 308 may only manage storage devices 204 and device adapters 210. Thus, the aggregation module 328 may only aggregate the queuing latencies of storage devices 204 and device adapters 210 which are used to process an I/O request to arrive at an overall queuing latency. If the I/O priority manager 308 is extended to manage additional devices (e.g., processors 212, cache 214, host adapters 208, etc.), the aggregation module 328 may incorporate the queuing latency from these additional devices into the overall queuing latency.

Upon determining the overall queuing latency, the storage system 110 may return the queuing latency to the host system 106. In certain embodiments, the queuing latency may be returned to the host system 106 with an I/O completion status 322 (indicating whether the I/O did or did not complete successfully). Upon receiving the queuing latency, an analysis module 312 within the host system 106 may analyze the queuing latency 314 and SLA 306 compliance 316 to determine how to most efficiently comply with the SLAs 306.

In certain cases, a priority adjustment module 318 may adjust the priority of one or more I/O workstreams when SLAs 306 are not being achieved and the adjustment would be helpful to achieving the SLAs 306. In other cases, a system administrator or data migration software may move data from lower performance storage devices 204 to higher performance storage devices 204, or vice versa, when doing so would be helpful to achieving SLAs 306. In yet other cases, a system administrator or data migration software may move data from one storage configuration (e.g., RAIDS) to another (e.g., RAID6) when doing such would be helpful to achieving SLAs 306. Any combination of such actions may be taken. Because the described feedback mechanism makes queuing latency within the storage system 110 known, host systems 106 and/or system administrators may make more intelligent decisions with regard to how to comply with SLAs 306.

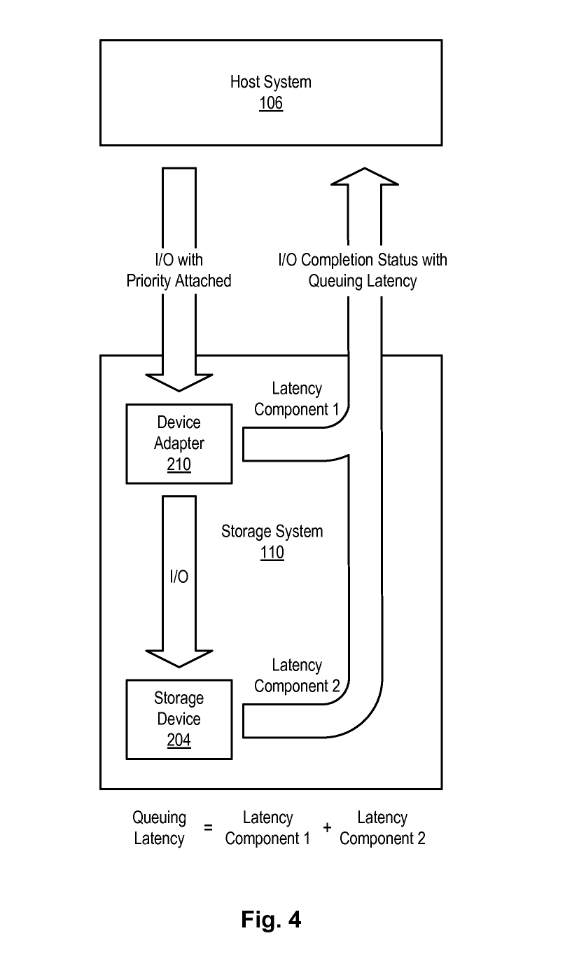

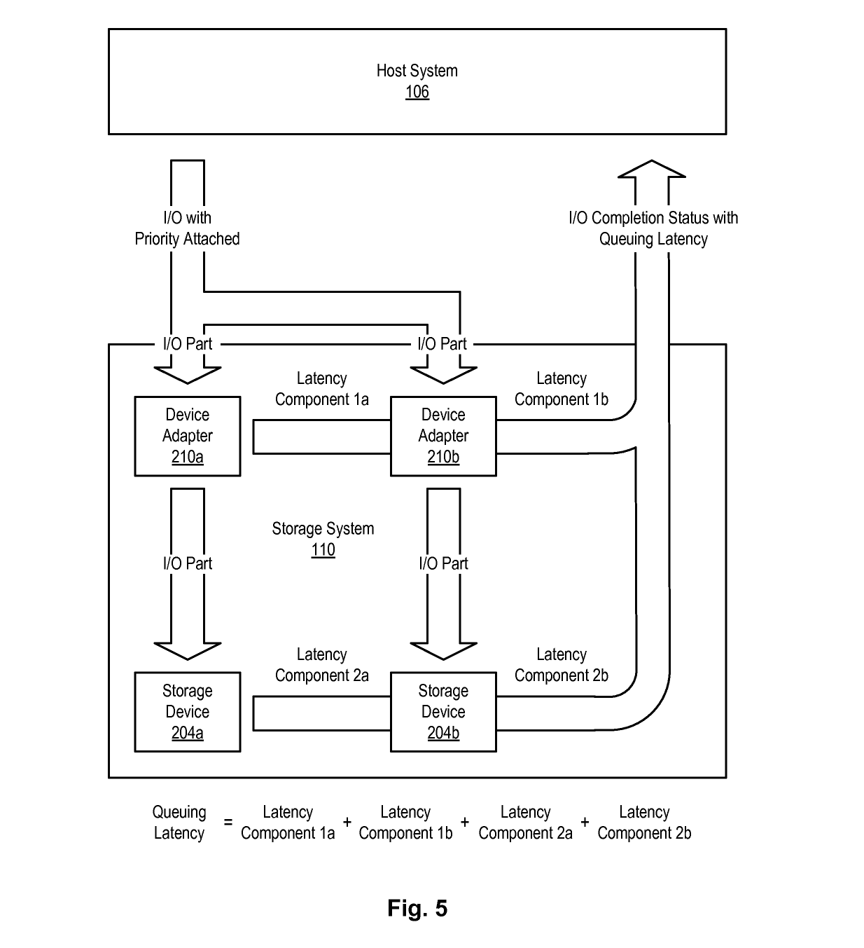

Referring to FIGS. 4 and 5, as previously mentioned, in certain embodiments, an aggregation module 328 may aggregate queuing latencies to provide an overall queuing latency for an I/O request. Different techniques may be used to aggregate such queuing latencies. For example, as shown in FIG. 4, an I/O request sent from a host system 106 to a storage system 110 may initially pass through a device adapter 210 before being processed on a storage device 204. A queuing latency may be present on the device adapter 210 and the storage device 204. To calculate an overall queuing latency, the aggregation module 328 may add a queuing latency component from the device adapter 210 to a queuing latency component from the storage device 204 and return the overall queuing latency to the host system 106.

As shown in FIG. 5, in certain cases, an I/O may be directed to multiple device adapters 210 and/or multiple storage devices 204. For example, a large I/O may be associated with data stored on several storage devices 204 of different performance levels. The host system 106 may be unaware of the underlying storage technology. In such case, the aggregation module 328 may add queuing latencies for all devices associated with the I/O to arrive at an overall queuing latency. For example, as shown in FIG. 5, a large I/O may be spread across multiple device adapters 210a, 210b and multiple storage devices 204a, 204b, in this example a pair of device adapters 210a, 210b and a pair of storage devices 204a, 204b. To calculate the overall queuing latency, the aggregation module 328 may add the queuing latency components of the device adapters 210a, 210b to the queuing latency components from the storage devices 204a, 204b to arrive at an overall queuing latency. This overall queuing latency may be returned to the host system 106 along with the I/O completion status.

The techniques for calculating queuing latency described in association with FIGS. 4 and 5 are exemplary in nature and are not intended to be limiting. Other techniques are possible and within the scope of the invention. For example, in other embodiments, individual queuing latency components for each device used to process an I/O request could be returned to the host system 106 and the host system 106 could either aggregate the queuing latency components at the host system 106 or analyze the queuing latency components individually. In other embodiments, the queuing latency components could be averaged or have other operations performed thereon either before or after being returned to the host system 106. Any type of information, regardless of format or form, that may assist the host system 106, applications 300 within the host system 106, or system administrators understand queuing latency characteristics inside the storage system 110 is deemed to be encompassed by the phrase “queuing latency” for purposes of the disclosure and claims.

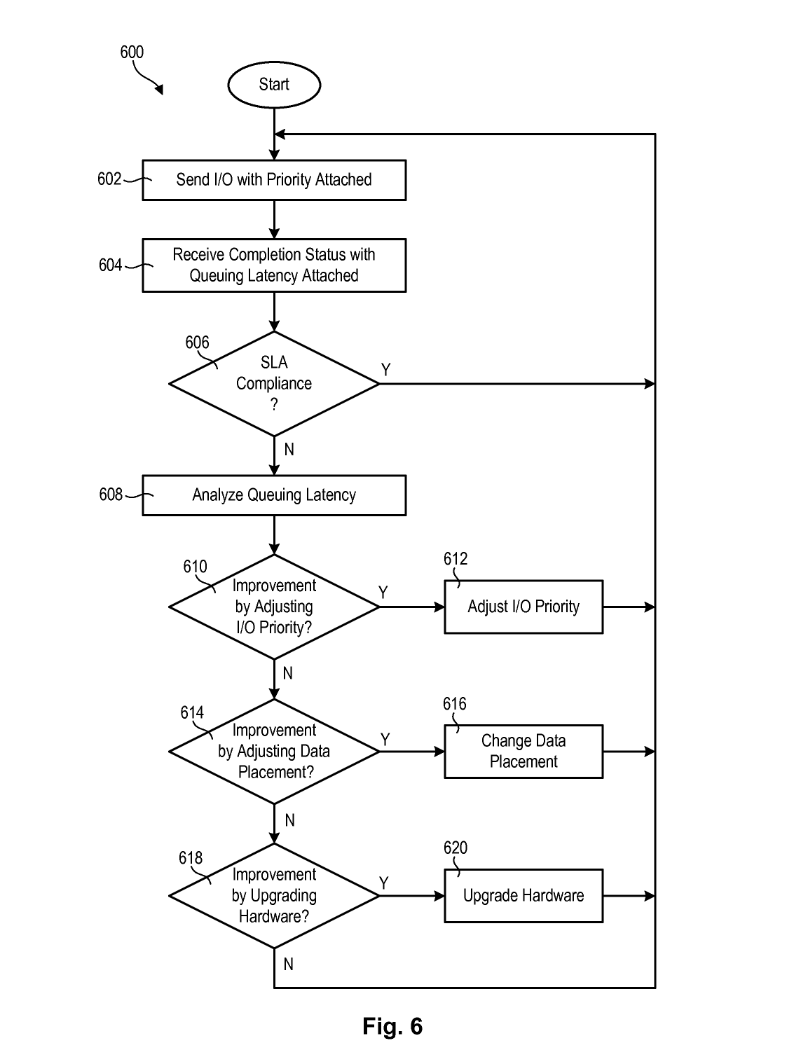

Referring to FIG. 6, a flow diagram showing one embodiment of a method 600 for generating queuing latency feedback and using the queuing latency feedback to make more intelligent decisions with regard to prioritizing I/Os is illustrated. In certain embodiments, such a method 600 may be executed by a host system 106, an application within the host system 106, or the like. As shown, the method 600 initially sends 602 an I/O request to a storage system 110. The method 600 then receives 602 a completion status with queuing latency attached. The method 600 further determines 606 whether the I/O (or its associated I/O workstream) is complying with an SLA 306. If the SLA 306 is being complied with, the method 600 may simply return to step 602 and send another I/O with priority attached.

However, if the SLA 306 is not being complied with, the method 600 analyzes 608 the queuing latency returned with the I/O completion status. If the method 600 determines 610 that SLA compliance may be improved by adjusting the priority of the I/O workstream (without negatively affecting other I/O workstreams and compliance with other SLAs 306), the method 600 may adjust 612 the priority of the I/O workstream. If the method 600 determines 614 that SLA compliance may be improved by adjusting data placement on the storage system 110, the method 600 may alter 616 data placement, such as by moving data to faster or slower storage media. Such movement may be initiated by a system administrator, data migration software, or the like. If, from the queuing latency, the method 600 determines 618 that SLA compliance may be improved by upgrading hardware on the storage system 110 (such as by installing higher performance storage devices 204), the method 600 may initiate 620 a hardware upgrade, such as by instructing a system administrator or other personnel to upgrade hardware.

The flowcharts and block diagrams in the Figures illustrate the architecture, functionality, and operation of possible implementations of systems, methods, and computer-usable media according to various embodiments of the present invention. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

1. A method for improving I/O performance using queuing latency feedback, the method comprising:
generating, at a host system, an I/O for processing on a storage system, the I/O having a priority association therewith;
receiving the I/O at the storage system;
measuring, by the storage system, queuing latency experienced by the I/O as the I/O is processed by the storage system;
returning, by the storage system, the queuing latency to the host system; and
using, by the host system, the queuing latency to adjust the priority of subsequent I/Os transmitted to the storage system.

2. The method of claim 1, wherein measuring the queuing latency comprises measuring a difference between an observed processing time of the I/O and an optimal processing time of the I/O.

3. The method of claim 1, wherein measuring the queuing latency comprises aggregating the queuing latency of multiple devices in the storage system that are used to process the I/O.

4. The method of claim 1, wherein returning the queuing latency to the host system comprising returning the queuing latency with an I/O completion status to the host system.

5. The method of claim 1, wherein adjusting the priority of subsequent I/Os occurs if the I/O is not complying with a service level agreement and the adjustment will improve I/O performance.

6. The method of claim 1, further comprising using the queuing latency to improve data placement on the storage system.

7. The method of claim 1, wherein receiving the I/O comprises receiving, at the storage system, the I/O with the priority.

8. A non-transitory computer-readable storage medium having computer-usable program code embodied therein, the computer-usable program code comprising:
computer-usable program code to generate, at a host system, an I/O for processing on a storage system, the I/O having a priority association therewith;
computer-usable program code to receive the I/O at the storage system;
computer-usable program code to enable the storage system to measure queuing latency experienced by the I/O as the I/O is processed by the storage system;
computer-usable program code to enable the storage system to return the queuing latency to the host system; and
computer-usable program code to use, at the host system, the queuing latency to adjust the priority of subsequent I/Os transmitted to the storage system.

9. The non-transitory computer-readable storage medium of claim 8, wherein measuring the queuing latency comprises measuring a difference between an observed processing time of the I/O and an optimal processing time of the I/O.

10. The non-transitory computer-readable storage medium of claim 8, wherein measuring the queuing latency comprises aggregating the queuing latency of multiple devices in the storage system that are used to process the I/O.

11. The non-transitory computer-readable storage medium of claim 8, wherein returning the queuing latency to the host system comprising returning the queuing latency with an I/O completion status to the host system.

12. The non-transitory computer-readable storage medium of claim 8, wherein adjusting the priority of subsequent I/Os occurs if the I/O is not complying with a service level agreement and the adjustment will improve I/O performance.

13. The non-transitory computer-readable storage medium of claim 8, further comprising computer-usable program code to use the queuing latency to improve data placement on the storage system.

14. The non-transitory computer-readable storage medium of claim 8, wherein receiving the I/O comprises receiving, at the storage system, the I/O with the priority.

15. A system for improving I/O performance using queuing latency feedback, the system comprising:
a host system to generate an I/O for processing on a storage system, the I/O having a priority association therewith;
the storage system configured to receive the I/O;
the storage system further configured to measure queuing latency experienced by the I/O as the I/O is processed by the storage system;
the storage system further configured to return the queuing latency to the host system; and
the host system further configured to use the queuing latency to adjust the priority of subsequent I/Os transmitted to the storage system.

16. The system of claim 15, wherein the storage system is configured to measure the queuing latency by measuring a difference between an observed processing time of the I/O and an optimal processing time of the I/O.

17. The system of claim 15, wherein the storage system is configured to measure the queuing latency by aggregating the queuing latency of multiple devices in the storage system that are used to process the I/O.

18. The system of claim 15, wherein the storage system is configured to return the queuing latency with an I/O completion status to the host system.

19. The system of claim 15, wherein the host system adjusts the priority of subsequent I/Os if the I/O is not complying with a service level agreement and the adjustment will improve I/O performance.

20. The system of claim 15, wherein at least one of the host system and the storage system is configured to use the queuing latency to improve data placement on the storage system.
